(19) United States
(12) Patent Application Publication
(10) Pub. No.: US 2026/0213703 A1
(43) Pub. Date: Jul. 23, 2026

(54) Retrofittable Electrodynamic Cleaning System (RECS) for Solar Panels

(71) Applicant: 1000892670 Ontario Inc (Swish Solar), Kitchener (CA)

(72) Inventors: Amirhossein Boreiri, Kitchener (CA); Miswar Akhtar Syed, Kitchener (CA)

(73) Assignee: 1000892670 Ontario Inc (Swish Solar), Kitchener (CA)

(21) Appl. No.: 19/452,996

(22) Filed: Jan. 20, 2026

Related U.S. Application Data
(60) Provisional application No. 63/747,185, filed on Jan. 20, 2025.

(51) Int. Cl. H02S 40/10; H02J 3/38; H02J 101/24

(52) U.S. Cl. CPC H02S 40/10; H02J 3/38; H02J 2101/25

(57) ABSTRACT

A retrofittable electrodynamic cleaning system for a photovoltaic module is disclosed. The system includes an electrodynamic retrofit film configured for attachment to a light-receiving surface of the photovoltaic module, the film comprising a plurality of nanomaterial electrodes (NMEs) arranged in one or more layers. A power and control unit is electrically connected to the electrodynamic retrofit film and includes at least one high-voltage generator configured to convert a low direct-current voltage into a higher-voltage, multi-phase alternating-current voltage waveform. The generated waveform is applied to the nanomaterial electrodes (NMEs) to produce an electrodynamic travelling wave that repels and removes debris from the panel surface. The power and control unit integrated on a single printed circuit board further includes a power extraction circuit with maximum power point tracking configured to draw operating power directly from the photovoltaic module for self-powered operation.

### CROSS REFERENCE TO RELATED APPLICATION

This application claims the benefit under 35 U.S.C. §119(e) of U.S. Provisional Application No. 63/747,185 entitled “DUAL-FUNCTION SELF-CLEANING DEVICE FOR DUST OR DEBRIS AND SNOW OR ICE REMOVAL FROM SOLAR PANELS AND METHODS OF REMOVING DUST OR DEBRIS AND SNOW OR ICE FROM SOLAR PANELS” filed on Jan. 20, 2025, which is incorporated herein by reference.

### TECHNICAL FIELD

The present invention relates generally to self-cleaning systems for photovoltaic modules, and more particularly to a Retrofittable Electrodynamic Cleaning System that can be attached to existing solar panels to automatically remove dust, snow, and other debris using electrodynamic forces, thereby improving energy yield without the use of water or manual labor.

### BACKGROUND

Generally, solar panels are susceptible to soiling, the accumulation of dust, sand, pollen, snow, and other debris on their surface. Soiling can significantly reduce the energy output of photovoltaic (PV) modules, with losses ranging from 10% to as high as 30-60% in extreme climates. In large solar farms or remote installations, maintaining panel cleanliness is a major challenge.

Conventional solutions for solar panel cleaning have various drawbacks. During manual cleaning, workers physically wash or brush the panels. The manual method is labor-intensive, costly, and impractical at scale (especially for thousands or millions of panels). Frequent manual cleaning also poses safety risks for workers and can cause gradual mechanical wear on the panels' surfaces.

A few prior arts disclose, water-based cleaning systems. The sprinklers or robotic cleaners use water and sometimes detergents to wash panels. These consume large amounts of water, a serious issue in arid regions where solar farms are often located. Water-based methods also require infrastructure (pumps, tanks, plumbing) and regular maintenance.

A few prior arts disclose, autonomous robotic cleaners. Some systems use robotic devices (wipers, brushes or crawler robots) that move across the panel array to wipe off dust. While reducing manual labor, these machines involve moving parts that can scratch panel surfaces or break down over time. They often require high capital expenditure (CAPEX) and still need periodic maintenance (battery charging, brush replacement, etc.). Additionally, many such robots cannot handle large installations without extensive rails or support systems.

Each of the prior art solutions suffers from issues such as high operational cost, dependence on water or consumables, mechanical complexity, and lack of scalability for utility-scale deployments. In off-grid or remote sites, these solutions may be infeasible. Furthermore, frequent use of water or brushes can shorten the lifespan of panels by abrasion or deposition of minerals.

One promising approach in the prior art is the use of electrodynamic screens (EDS) to remove dust. An electrodynamic screen consists of nanomaterial electrodes (NMEs) laid on the panel surface; when activated with high voltage alternating signals, it generates oscillating electrostatic fields that can charge and repel dust particles, effectively “lifting” and transporting them off the glass. Such EDS-based cleaning requires minimal electricity and no water and has been demonstrated to clear a dusty panel with only a few watt-hours of energy per square meter. This technique avoids moving mechanical parts and can preserve panel transparency (modern electrode coatings can achieve over 99% light transmission through the film.

However, implementing an electrodynamic cleaning system on actual solar panels presents several technical challenges. A complete system needs a high-voltage power source to drive the EDS film, control electronics to manage the timing and waveform of the voltage, sensors to determine when cleaning is needed, a safe and weatherproof housing for outdoor use, and a power supply for the electronics. Further for retrofitting, the system must operate autonomously and draw power from the panel itself (since external wiring or batteries would complicate installation). Until now, no integrated unit has been available that combines all these functions into a compact device for on-panel use. Prior approaches to EDS cleaning often relied on lab setups or separate components and did not address how to seamlessly integrate into an existing PV array's electrical and mounting infrastructure.

### SUMMARY

The invention provides a retrofittable electrodynamic cleaning system for a photovoltaic module, comprising an electrodynamic retrofit film (ERF) configured to be affixed to a light-receiving surface of the photovoltaic module, wherein the electrodynamic retrofit film (ERF) comprises a plurality of nanomaterial electrodes (NMEs) arranged in one or more layers, and a power and control unit (PCU) electrically connected to the electrodynamic retrofit film (ERF) to enable electrodynamic cleaning of the photovoltaic module.

In yet another aspect, the PCU comprises at least one high-voltage generator configured to receive a low direct-current (DC) voltage and generate a higher-voltage, multi-phase alternating-current (AC) voltage waveform, wherein the at least one high-voltage generator includes one or more multi-phase switching circuit and drivers electrically coupled to the plurality of nanomaterial electrodes (NMEs) and configured to apply the multi-phase AC voltage waveform to the plurality of nanomaterial electrodes (NMEs) to generate an electrodynamic travelling wave for repelling and removing debris from the light-receiving surface of the photovoltaic module.

In an aspect, the PCU further comprises at least one power extraction circuit electrically connectable to one or more output terminals of the photovoltaic module, the power extraction circuit comprising one or more maximum power point tracking (MPPT) modules configured to execute a maximum power point tracking logic to (i) draw operating power from the photovoltaic module for self-powered operation of the PCU and (ii) control an operating point of the photovoltaic module at or near a maximum power point such that a remaining portion of power generated by the photovoltaic module is delivered, at an increased efficiency, to one or more external loads and/or an electrical grid, without materially interfering with normal power generation.

In yet another aspect, the PCU includes a plurality of sensor circuits configured to receive one or more sensor signals indicative of one or more environmental and operating parameters of the photovoltaic module and the electrodynamic retrofit film (ERF), and a microprocessor operatively coupled to the high-voltage generator, the one or more multi-phase switching circuits, the power extraction circuit, and the plurality of sensor circuits, wherein the microprocessor is programmed to process the sensor signals to determine a soiling condition of the photovoltaic module and to initiate and control cleaning cycles based on the determined soiling condition.

In an aspect, the PCU further comprises a wireless communication module operatively coupled to the microprocessor, the wireless communication module being configured to connect the microprocessor to a remote software module network for data monitoring, remote control, and firmware updates, wherein the PCU is integrated on a single printed circuit board and implements closed-loop feedback to dynamically initiate, control, and verify electrodynamic cleaning cycles based on the sensor signals.

In yet another aspect, the high-voltage generator is configured to generate a three-phase alternating-current voltage waveform, and the plurality of nanomaterial electrodes (NMEs) is arranged into interleaved phase groups to produce a laterally propagating electrodynamic travelling wave, wherein the high-voltage generator may include a hybrid switching architecture and a DC-DC booster circuit capable of producing kilovolt-range output voltages at low current levels.

In an aspect, the plurality of sensor circuits includes one or more environmental sensors and electrical power sensing circuits, and the microprocessor determines the soiling condition by comparing measured electrical output of the photovoltaic module to an expected electrical output normalized to irradiance, while employing noise-reduction, signal-conditioning, and isolation-aware circuit techniques to ensure reliable sensing in proximity to high-voltage switching circuit.

In yet another aspect, the microprocessor supports multiple operating modes including a fully autonomous mode, a remote-controlled mode, and a manual mode, and is further configured to inhibit cleaning cycles under unsafe environmental or electrical operating conditions, such as rain, excessive humidity, or abnormal electrical parameters.

In an aspect, the electrodynamic retrofit film (ERF) comprises nanomaterial electrodes (NMEs) formed from transparent conductive materials including indium tin oxide (ITO), aluminum-doped zinc oxide (AZO), silver nanowires, carbon nanotube networks, or transparent conductive oxide composites, and the PCU is housed in an outdoor-rated, weather-resistant enclosure suitable for retrofit installation on existing photovoltaic modules without modification of panel glass, junction boxes, or electrical wiring.

In yet another aspect, a method is disclosed for autonomously removing debris from a photovoltaic module using the retrofittable electrodynamic cleaning system, comprising providing the electrodynamic retrofit film (ERF) on the light-receiving surface, mounting the PCU on the photovoltaic module, drawing operating power from the photovoltaic module using MPPT-based power extraction, monitoring environmental and electrical parameters, estimating a soiling condition, autonomously initiating a cleaning cycle using a multi-phase high-voltage AC waveform, generating an electrodynamic travelling wave to dislodge debris, verifying cleaning effectiveness through sensor feedback, and adjusting subsequent cleaning parameters using closed-loop feedback.

In an aspect, the method further comprises transmitting operational data and cleaning history to a remote monitoring platform via the wireless communication module and receiving remote commands to initiate cleaning cycles thereby enabling both autonomous and remotely supervised operation of the retrofittable electrodynamic cleaning system.

In an aspect, the retrofittable electrodynamic cleaning system (RECS) is configured as a modular retrofit assembly, wherein all functional components including a high-voltage waveform generator, DC-DC booster circuit, control electronics, sensor circuits, and a wireless communication module are consolidated onto a single compact printed circuit board (PCB). The PCB is housed within an outdoor-rated, weatherproof enclosure configured for direct mounting on a photovoltaic module.

In yet another aspect, the enclosure is dimensioned and mechanically configured for on-panel mounting and utilizes standard photovoltaic connector interfaces to enable simplified electrical integration. The form factor and mounting approach are preferably analogous to those of commercially deployed microinverters or DC power optimizers, such that the RECS can be attached to a photovoltaic module frame or associated mounting rails while interfacing with existing panel wiring with minimal modification.

In an aspect, the modular configuration enables the RECS to function as a plug-and-play retrofit for existing photovoltaic installations. Installation may be performed by affixing the electrodynamic retrofit film to the light-receiving surface of the photovoltaic module, electrically coupling leads of the electrodynamic retrofit film to the power and control unit (PCU), and electrically connecting an input of the PCU to a junction box or output cables of the photovoltaic module.

In yet another aspect, the RECS is configured to operate without external power supplies or additional field wiring, wherein operating power is drawn directly from the photovoltaic module via the integrated power extraction circuit. This self-contained, modular architecture enables rapid deployment, reduced installation complexity, and compatibility with a wide range of existing photovoltaic module installations.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIG. 1 illustrates a system architecture of a retrofittable electrodynamic cleaning system (RECS) 100, in accordance with embodiments of the present disclosure;

FIG. 2 illustrates a general schematic of the RECS hardware module 200, in accordance with embodiments of the present disclosure;

FIG. 3a illustrates a two-layer electrode configuration integrating electrodynamic retrofit film (ERF) directly with a photovoltaic module, in accordance with embodiments of the present disclosure;

FIG. 3b illustrates an alternative two-layer electrode configuration with nanomaterial electrodes (NMEs), deposited on a separate substrate assembly for use as a retrofittable ERF, in accordance with embodiments of the present disclosure;

FIG. 3c illustrates a one-layer electrode configuration with nanomaterial electrodes (NMEs) directly printed onto the surface of a photovoltaic module, in accordance with embodiments of the present disclosure;

FIG. 3d illustrates an alternative one-layer electrode configuration with nanomaterial electrodes (NMEs) deposited on a separate substrate forming an Electrodynamic Retrofit Film (ERF) positioned above a photovoltaic module, in accordance with embodiments of the present disclosure;

FIG. 4 is a schematic representation of the Power and Control Unit (PCU) configuration that is self-powered from the solar panel, in accordance with embodiments of the present disclosure;

FIG. 5a illustrates a schematic representation of one or more power extraction circuits in a Retrofittable electrodynamic Cleaning System (RECS) in accordance with the embodiments of the present disclosure;

FIG. 5b illustrates the one or more power extraction circuits coupled to the power and control unit in the Retrofittable electrodynamic Cleaning System (RECS), in accordance with embodiments of the present disclosure; and

FIG. 5c illustrated the self-contained RECS integrating the photovoltaic module, the PCU with MPPT unit, in accordance with embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

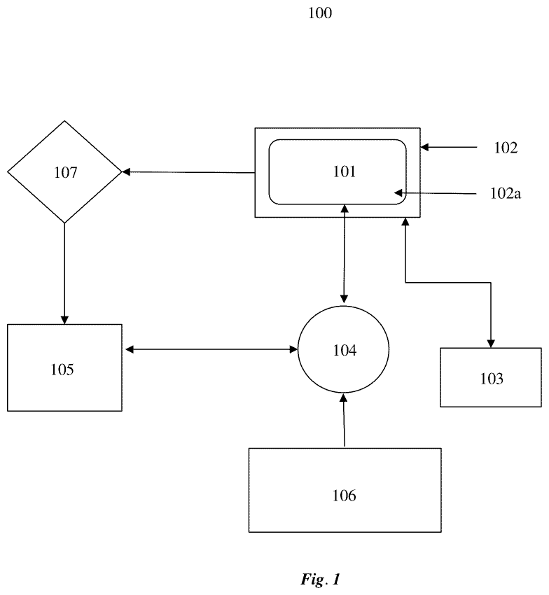

Detailed embodiments of the invention are described below with reference to FIGS. 1-5. These examples illustrate specific implementations and should not be construed as limiting the scope of the invention, which is defined by the claims.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Throughout the present disclosure, various synonyms may be used to refer to dust, debris, or contaminants that are cleared, removed, or otherwise mitigated by the present disclosure. It will be appreciated that all such synonyms and mitigation are to be considered the first functionality of the present disclosure.

Throughout the present disclosure, various synonyms may be used to refer to snow, ice, or like substances that are cleared, removed, or otherwise melted or mitigated by the present disclosure. It will be appreciated that all such synonyms and mitigation are to be considered a second functionality of the present disclosure.

The following relates generally to photovoltaic modules or solar panels, and more particularly to devices for removing dust or debris and snow or ice from the photovoltaic modules and methods of removing dust or debris and snow or ice from photovoltaic modules.

Various embodiments include at least one of systems, methods, and software to facilitate automatic (e.g., autonomous) photovoltaic modules surface cleaning. Solar power surfaces can include, but are not limited to, photovoltaic modules, photovoltaic (PV) solar cells, mirrors used in Concentrating Solar Power (CSP) plants, other surfaces, and combinations thereof. Surfaces can be used to generate solar power either directly or indirectly. The solar panel and the photovoltaic module can be interchangeably used in the patent specification.

It should first be noted that the systems and methods will be discussed below with reference to a photovoltaic module or a solar panel. However, it is noted that the systems and methods of the present disclosure can be used with any system, including but not limited to, windows, vehicle surfaces, vehicle windshields, optical devices, etc., such that the electrodynamic shield allows for automatic cleaning of such objects.

In one embodiment, the system architecture is illustrated using block diagrams, where arrows represent data flow and communication pathways between modules. The arrows indicate the direction in which information, model parameters, or control signals are transmitted from one component to another. The arrows do not imply a specific physical medium or network protocol; rather, they denote logical communication relationships between modules within the system.

In an embodiment, one or more modules may transmit data, a message, or a model update to another module along a unidirectional arrow. In another embodiment, bidirectional arrows indicate that the connected modules exchange information or perform synchronized operations. The communication may occur through direct internal calls within the system, via Application Programming Interfaces (APIs), or through network-based communication channels, depending on deployment.

In some embodiments, the arrows represent communication occurring through secure protocols. The system may encrypt data transmitted between modules or may transmit only derivative artifacts such as model parameters, ensuring that sensitive data remains protected. In all embodiments, the arrows are intended to illustrate the sequence and relationship of operations performed by the system modules. The arrows do not limit the system to a specific implementation or transport mechanism.

As used herein, the term “Electrodynamic retrofit film (ERF)” is defined as a transparent multi-layer that is placed on the surface of the photovoltaic module or solar panel and is designed to keep the panel clean. The film contains thin electrodes that receive an electrical signal. When a controlled three-phase high-voltage signal is applied, the film creates a moving electric field along its surface. The moving electric field charge and repulse dust and small particles off the solar panel. The cleaning process restores solar energy output and does not require water, brushes, or any mechanical cleaning parts.

As used herein, the term “an electrodynamic travelling wave” is a moving electric field created along a surface or structure by applying multiple electrical signals with controlled phase differences to a set of electrodes. The phase-shifted signals cause the electric field to propagate in a defined direction over time. As the electric field travels, it exerts electrostatic forces on nearby charged or polarizable particles, causing them to move in the same direction as the wave. This effect can be used to transport, repel, or remove particles, such as dust, without physical contact.

As used herein, the term “Power and Control Unit (PCU)” is an electronic subsystem configured to supply electrical power and control signals to other components of a system for managing energy. Generally, PCU consists of three components: an inverter, a boost converter to increase voltage, and a DC-DC converter to lower voltage, microcontroller/microprocessors, MPPT, Switches, MOSFETs and gate drivers, and sensors.

As used herein, the term “soiling level” refers to the degree of dirt, dust, or buildup on a surface.

As used herein, the term “MPPT or Maximum Power Point Tracking” is algorithm that included in charge controllers and DC optimizer used for extracting maximum available power from photovoltaic module under multiple conditions. The voltage at which a photovoltaic module can produce maximum power is called the maximum power point (or peak power voltage). Maximum power varies with solar radiation, ambient temperature and solar cell temperature.

As used herein, the term “Gate driver” is a power amplifier that accepts a low-power input from a controller IC and produces a high-current drive input for the gate of a high-power transistor, such as an IGBT or power MOSFET. Gate drivers can be provided either on-chip or as a discrete module. In essence, a gate driver consists of a level shifter in combination with an amplifier. A gate driver IC serves as the interface between control signals (digital or analog controllers) and power switches (IGBTs, MOSFETs, SiC MOSFETs, and GaN HEMTs).”

As used herein, the term “Pulse width modulation (PWM)” is a type of digital signal that can be used to control the input voltage with digital position feedback signals, through a series of on-off pulses. Pulse-width modulation is commonly used for speed control of a motor. The wider the pulses the higher the average input voltage and the narrower the pulses, the lower the input voltage.

As used herein, the term “Solid-State Relays” are electronic switching devices that use semiconductor components instead of mechanical contacts to control electrical loads. They provide fast switching speeds, long operational lifetimes, and silent operation due to the absence of moving parts. Solid-state relays are well suited for high frequency switching and PWM control.

As used herein, the term “MOSFET (Metal-Oxide-Semiconductor Field-Effect Transistor) is a semiconductor device used to control the flow of electrical current in a circuit. It operates by applying a voltage to a gate terminal, which creates an electric field that allows or blocks current flow between a source terminal and a drain terminal. MOSFETs are widely used because they offer fast switching speed, high efficiency, and low power consumption.

As used herein, the term “MOSFET-Based Switching” refers to the use of one or more MOSFETs as electronic switches to control electrical power in a circuit. The MOSFET is turned on and off by a control signal applied to its gate, enabling rapid and precise control of current flow.

The following detailed description outlines various embodiments of the retrofittable electrodynamic cleaning system (RECS) and methods for its use. All examples given are illustrative and not intended to limit the scope of the invention, which is defined by the claims. For clarity, in the figures and description, like parts are given like reference numerals.

FIG. 1 illustrates a system architecture of a retrofittable electrodynamic cleaning system (RECS) 100, in accordance with embodiments of the present disclosure. The system 100 comprises a plurality of internal system components and a plurality of external system components operatively coupled thereto. The system 100 integrates both the plurality of internal system components (which belong to the RECS system 100) and the plurality of external system components (which interact with RECS but are not part of the system 100). The plurality of internal system components includes an electrodynamic retrofit film (ERF) 101 configured for installation on a photovoltaic module 102, one or more sensors 103, a power and control unit (PCU) 104, and a software module 105. The internal system components are communicatively and electrically coupled via wired and/or wireless communication links.

In one example embodiment, the wired links may include, but not limited to electrical power lines, control signal cables, or data communication interfaces such as Universal Asynchronous Receiver-Transmitter (UART), Inter-Integrated Circuit I²C, Serial Peripheral Interface (SPI), Ethernet, or RS-485 connections between the power and control unit (PCU) 104, the one or more sensors 103, and electrodynamic retrofit film (ERF) 101. Further, the wireless links may include but are not restricted to short-range or long-range communication technologies such as Wi-Fi, Bluetooth, Zigbee, LoRa, cellular communication, or other radio-frequency protocols.

Further, the plurality of external system components includes the photovoltaic module 102, an external power source 106 configured to supply operating power to the power and control unit (PCU) 104. In some embodiments, an external power source 106 configured to supply operating power to the power and control unit (PCU) 104. In other embodiments, the PCU 104 is configured to receive operating power from the photovoltaic module 102, such that the external power source 106 may be omitted.

In certain embodiments, a third-party solar monitoring application 107 is configured to communicate with the software module 105 when performance data of the system is not collected directly by the retrofittable electrodynamic cleaning system (RECS) 100.

Referring to FIG. 1, a typical installation is shown wherein a photovoltaic module 102 is outfitted with the RECS 100. The photovoltaic module 102 has a front glass surface 102a on which the electrodynamic retrofit film (ERF) 101 is installed. The ERF 101 is a thin, transparent sheet configured to cover some or all of the active area of the photovoltaic module 102 and is retrofitted onto the front glass surface 102a. The ERF 101 comprises a pattern of electrodes, including nanomaterial electrodes (NMEs), arranged in an interdigitated configuration.

In one embodiment, the Retrofittable Electrodynamic Cleaning System (RECS) 100 includes a software module 105 executed by the power and control unit (PCU) 104, by a remote computing device, or by a combination thereof. The software module 105 is functionally coupled to the plurality of sensors 103 and to the power and control unit (PCU) 104 of the Retrofittable Electrodynamic Cleaning System (RECS) 100. The software module 105 processes one or more sensor measurements corresponding to physical operating conditions and generates control signals that directly actuate the electrodynamic retrofit film (ERF) 101 through the power and control unit (PCU) 104. In an example embodiment, the software module 105 collects operational data of the Retrofittable Electrodynamic Cleaning System (RECS) 100 including, but not limited to environmental exposure, irradiance, temperature, humidity, electrical output, and cleaning activity. The software module 105 also generates numerical and graphical performance indicators and identifies faults or losses attributable to soiling conditions of the Retrofittable Electrodynamic Cleaning System (RECS) 100. The one or more historical and real-time data generated by the software module 105 are analyzed to detect anomalous operating behavior and to predict degradation or failure conditions so that maintenance actions may be scheduled prior to yield reduction.

Furthermore, the software module 105 also determines optimal cleaning schedules based on correlations between the operational data including, but not limited to environmental exposure, irradiance, temperature humidity, electrical output, cleaning activity, and electrical performance deviations, and historical trends. Based on the cleaning schedules, the cleaning operations may be initiated automatically or recommended for execution. The optimization logic is not limited to electrodynamic cleaning and may be applied to alternative cleaning methods.

In one example embodiment, the software module 105 can also estimate soiling levels without requiring a dedicated soiling sensor. The estimation can be derived from correlations between measured electrical output, expected output based on irradiance and weather data, and historical performance models, but are not limited to. Further, one or more external data sources, including weather or satellite datasets, may be incorporated. The resulting soiling estimate provides a quantified input used by the control logic to trigger or suppress cleaning operations.

In another embodiment, the software module 105 may operate independently of the electrodynamic retrofit film (ERF) 101. In a standalone configuration, the software module 105 monitors photovoltaic module 102 performance, detects faults, predicts energy losses, and generates maintenance schedules. The standalone configuration provides technical benefit without requiring cleaning hardware and remains compatible with later integration of electrodynamic components. The disclosed system 100 reduces water usage, eliminates mechanical wear, and improves energy yield through targeted, condition-based cleaning. Integration of sensor-driven control with electrodynamic actuation enables reliable, autonomous operation with reduced operational cost and resource consumption.

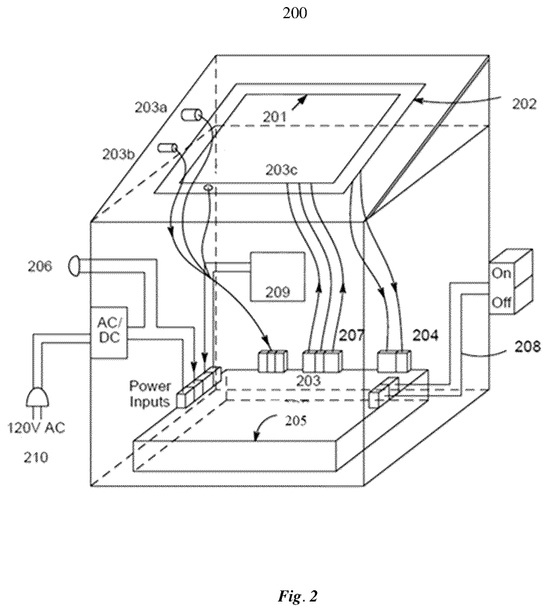

FIG. 2 illustrates a general schematic of the hardware module of Retrofittable Electrodynamic Cleaning System (RECS) 200, in accordance with the embodiments of the present invention. The hardware module of the Retrofittable Electrodynamic Cleaning System (RECS) 200 illustrates one or more components of the Retrofittable Electrodynamic Cleaning System (RECS) 200 integrated on a single printed circuit board (PCB) 205, which in the illustrated embodiment corresponds to the power and control unit (PCU) 205. The hardware module 200 illustrate the structure and interconnections between a electrodynamic retrofit film (ERF) 201, a photovoltaic module 202, a plurality of sensors 203, a Power and Control Unit (PCU) 205, one or more switches 206 such as but not limited to emergency switch, three-phase high-voltage signal connections (from the ERF 201 to the PCU 205) 207, an encapsulation box 208, one or more power-supply configurations including a backup battery 209, an input power supply (120V AC input) 210 and a power input from the photovoltaic module 202 to the PCU 205 (connection 204). The connection 204 is an electrical output of the photovoltaic module being routed into the PCU 205 as an input. The AC input 210 and the backup battery 209 are optional power-supply configurations for the PCU. In other embodiments, the PCU may receive operating power directly from the photovoltaic module 202; accordingly, elements 209 and 210 are optional components.

In certain embodiments, the sensors 203 include a humidity sensor, an ambient temperature sensor, and an irradiance sensor mounted on an exterior surface of the encapsulation box 208 to sample environmental data. In certain embodiments, one or more optional switches 206 (e.g., a manual override switch and/or an emergency switch) may be included to provide manual control. In other embodiments, the PCU 205 is configured to be controlled via a wireless communication link, and the switches 206 may be omitted. Further, the backup battery 209 and the input power supply 210 are optional and may be omitted in embodiments where the PCU 205 receives operating power from the photovoltaic module 202 via the connection 204. The schematic illustrated in FIG. 2 highlights one or more electrical and data connections including the internal flow of control signals, power, and data, as well as the interconnection between the hardware components of the RECS system 200.

The schematic illustrated in FIG. 2 highlights one or more electrical and data connections such as the internal flow of control signals, power and data, as well as the interconnection between the hardware components of the RECS system 200.

The PCB 205 includes only components of the power and control unit (PCU). Accordingly, the PCB and PCU refer to the same assembly for purposes of this disclosure.

In one embodiment, the electrodynamic retrofit film (ERF) 201 comprises a thin, multilayer structure configured for removal of dust and particulate matter from a surface of the photovoltaic module 202. The electrodynamic retrofit film (ERF) 201 includes a plurality of nanomaterial-based electrodes (NMEs) disposed between one or more dielectric layers. The electrodynamic retrofit film (ERF) 201 is configured to be applied directly onto an exposed surface of the photovoltaic module 202 while maintaining a high level of optical transparency to allow transmission of solar irradiance to the underlying photovoltaic modules. As illustrated in FIG. 2, the electrodynamic retrofit film (ERF) 201 is a transparent retrofit layer that performs dust removal through electrodynamic forces. The transparent retrofit layer is configured to apply the three-phase high-voltage signal 207 to the electrodynamic retrofit film (ERF) 201 to repel and dislodge dust particles from the surface of the photovoltaic module 202 without the use of water or mechanical cleaning.

As illustrated in FIG. 2, the hardware module of the RECS system 200 further includes a plurality of sensors 203 operatively coupled to a power and control unit 205. In certain embodiments, the hardware module of the RECS system 200 comprises one or more sensors 203a, 203b, and 203c, as illustrated in FIG. 2 which may include, but are not limited to, environmental sensors, and ambient temperature sensors. The sensor 203a is a humidity sensor, 203b is an ambient temperature sensor, and 203c is an irradiance sensor. These sensors are integrated on (or mounted to) the exterior surface of an encapsulation box 208 (enclosure 208) to sample real environmental data. The said environmental sensors are configured to measure temperature, humidity, and solar irradiance. Further, the electrical sensors are integrated into the PCU 205 and configured to measure voltage, current, and power output associated with the photovoltaic module 202 and the RECS system 200. The plurality of sensors 203 provides one or more sensor data to the power and control unit 205. The sensor data indicated by the arrows in FIG. 2 from the one or more sensors 203a, 203b, and 203c towards the power and control unit 205 integrated on the PCB 205 represents real-world operating conditions and electrical performance of the photovoltaic module 202 and the RECS system 200.

As illustrated in FIG. 2, the hardware module of the RECS system 200 further includes the power and control unit 205 which is electrically coupled to the electrodynamic retrofit film (ERF) 201 on the photovoltaic module 202. The power and control unit 205 is configured to generate and apply a multi-phase high-voltage signal 207 or a three-phase high-voltage signal 207 to the plurality of nanomaterial-based electrodes (NMEs) of the electrodynamic retrofit film (ERF) 201. The application of the multi-phase high-voltage signal 207 as an input to the electrodynamic retrofit film (ERF) 201 of the photovoltaic module 202 produces a time-varying electric field across the surface of the electrodynamic retrofit film (ERF) 201. The electric field exerts electrodynamic forces on dust and particulate matter present on the surface, causing the particles to lift, repel, and migrate away from the active light-receiving area of the photovoltaic module 202. The dust removal is achieved without the use of liquids, mechanical contact, or moving parts. In a particular embodiment, the power and control unit 205 may be activated manually, remotely, or automatically. In an automated mode, a processor within the power and control unit 205 samples the sensor data, evaluates operating conditions, and determines a timing and duration of a cleaning cycle for cleaning the electrodynamic retrofit film (ERF) 201 using electrodynamic forces.

In an embodiment, the electrical output of the photovoltaic module 202 being routed into the PCU 205 as an input. In certain embodiments, this input may be used (i) as an optional operating power source for the PCU, (ii) as a signal path for monitoring and reporting yield data, and/or (iii) to enable maximum power point tracking/optimization via a DC optimizer (MPPT) functionality implemented by the PCU 205, with the resulting output optionally provided to the grid.

In certain embodiments, the switches 206 are optional and may be omitted, for example when the PCU 205 is configured to be controlled via a wireless communication link (e.g., through the software module and/or a third-party monitoring application), thereby reducing or eliminating a need for manual switches.

In one particular embodiment, the Retrofittable Electrodynamic Cleaning System (RECS) 200 is provided as an integrated hardware software system configured to reduce soiling losses in the photovoltaic module 202. The Retrofittable Electrodynamic Cleaning System (RECS) hardware module 200 integrated on the single printed circuit board (PCB) 205 and connected with the software module 105 (illustrated in FIG. 1 above) form an autonomous, closed-loop system for dust removal, monitoring, and optimization of performance of the photovoltaic module 202.

In one embodiment, as illustrated in FIG. 2, the RECS system 200 includes a retrofit-optimized encapsulation box 208 and wiring architecture configured for installation on existing photovoltaic modules. The encapsulation box 208 provides dedicated internal routing paths for high-voltage conductors between the PCU 205 and the electrodynamic retrofit film (ERF) 201. The encapsulation box incorporates environmental sealing elements to protect internal electronics from moisture, dust, and ultraviolet exposure, and includes a replaceable fusing interface accessible without photovoltaic module 202 disassembly. The low-voltage conductors between the photovoltaic panel 202 and the PCU 205 are routed through standardized strain-relieved channels to minimize installation complexity and enable compatibility with existing panel layouts.

In a further aspect of this embodiment, the RECS system 200 is enclosed within a retrofit-ready housing configured for attachment to an existing photovoltaic panel, wherein field installation is accomplished by mechanically mounting the unit and connecting a limited number of electrical interfaces. The housing and electrical architecture are compatible with standard photovoltaic panel form factors. The embodiment further includes wireless communication capability, enabling remote monitoring, control, and data exchange with a cloud-based platform for system supervision and predictive cleaning strategies.

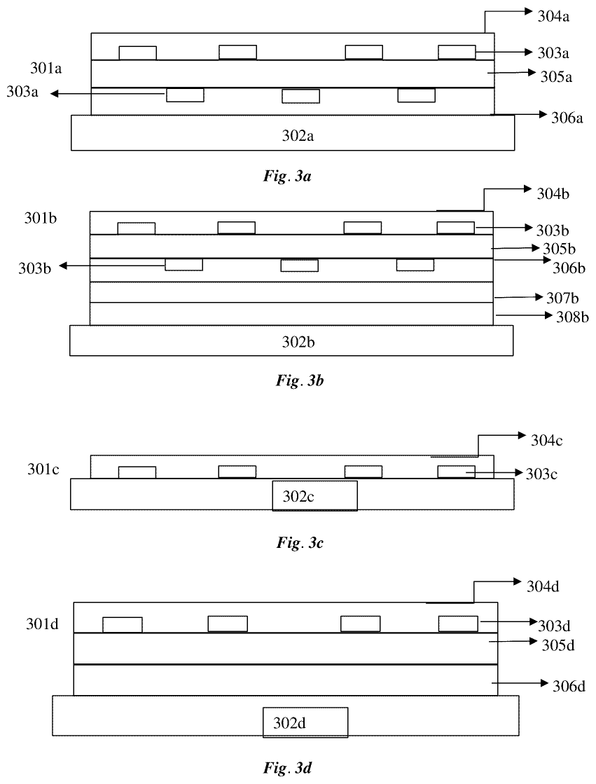

FIG. 3a illustrates a two-layer electrode configuration in which an electrodynamic retrofit film (ERF) 301a is directly integrated with a photovoltaic module 302a, in accordance with embodiments of the present invention. As shown, a coating layer 304a is disposed on an outer surface of the electrodynamic retrofit film (ERF) 301a, providing environmental protection and optical transmission. A plurality of nanomaterial electrodes (NMEs) 303a are arranged below the coating layer 304a and are positioned in operative proximity to the light-receiving surface of the photovoltaic module 302a. The nanomaterial electrodes (NMEs) 303a are supported by a substrate 305a, which is bonded to the photovoltaic module 302a by an adhesive layer 306a. In the said configuration, the nanomaterial electrodes (NMEs) 303a are effectively adhered to the panel surface through the substrate 305a and adhesive layer 306a, enabling the generation of an electrodynamic field across the surface of the photovoltaic module 302a to repel and dislodge particulate matter.

In an embodiment, the electrodynamic retrofit film (ERF) 301a comprises one or more nanomaterial electrodes (NMEs) 303a sandwiched among one or more dielectric layers, applied directly on the surface of the photovoltaic module 302a while maintaining high irradiance transmission. The RECS system 300 power supply generates a three-phase high-voltage, low-frequency waveform that excites the one or more nanomaterial electrodes (NMEs) 303a. As a result, dust particles deposited on the electrodynamic retrofit film (ERF) 301a surface become electrostatically charged and are transported off the panel surface through the action of the traveling electrostatic field. The three-phase configuration creates a propagating wave that imparts a translational velocity to dust and sand particles, ensuring effective cleaning without the need for water or mechanical abrasion. The electrodynamic retrofit film (ERF) 301a leverages advanced nanomaterial-based transparent, conductive electrodes to maximize both electrostatic force generation and optical transparency.

FIG. 3b illustrates an alternative two-layer electrode configuration in which the nanomaterial electrodes (NMEs) are deposited on a separate substrate assembly 305b, forming the electrodynamic retrofit film (ERF) 301a positioned above a photovoltaic module 302b. The substrate assembly comprises an upper substrate 305b and a lower substrate 307b. As shown, a coating layer 304a is disposed on the upper substrate 305b, beneath which a plurality of nanomaterial electrodes (NMEs) 303b are formed. The upper substrate 305b is coupled to a lower substrate 307b by an intermediate adhesive layer 306b, providing additional structural support and electrical isolation. The lower substrate 307b is, in turn, coupled to the photovoltaic module 302b by an additional adhesive layer 308b. The layered arrangement spaces the nanomaterial electrodes (NMEs) 303b from the photovoltaic module 302b while maintaining functional proximity. The proposed arrangement enhances mechanical robustness, electrical insulation, and retrofit compatibility while still enabling formation of an electrodynamic field for dust removal.

FIG. 3c illustrates a one-layer electrode configuration in which nanomaterial electrodes (NMEs) 303c are directly printed onto the surface of a photovoltaic module 302c. As shown, the nanomaterial electrodes (NMEs) 303c are formed in direct contact with the photovoltaic module 302c and are covered by a coating layer 304c that provides environmental protection while maintaining optical transmission. In this configuration, the printed nanomaterial electrodes (NMEs) 303c are disposed in immediate operative proximity to the light-receiving surface of the photovoltaic module 302c, thereby enabling generation of an electrodynamic field sufficient to repel and dislodge particulate matter without the use of a separate substrate layer.

FIG. 3d illustrates an alternative one-layer electrode configuration in which nanomaterial electrodes (NMEs) 303d are deposited on a separate substrate forming an electrodynamic retrofit film (ERF) 301d positioned above a photovoltaic module 302d. As shown, the nanomaterial electrodes (NMEs) 303d are supported by a substrate 305d and covered by a coating layer 304d. The substrate 305d is coupled to the photovoltaic module 302d by an adhesive layer 306d. This configuration provides additional mechanical support and electrical isolation while maintaining functional proximity between the nanomaterial electrodes (NMEs) 303d and the photovoltaic module 302d, thereby enabling formation of an electrodynamic field for dust removal.

In an example embodiment, the Electrodynamic Retrofit Film (ERF) 301a, 301b, 301c, 301d, disclosed in FIGS. 3a, 3b, 3c, and 3d, comprise a plurality of functional layers arranged in a stacked configuration. The number, order, and composition of the layers may vary depending on the nanomaterial electrodes (NMEs) configuration (303a, 303b, 303c and 303d disclosed in FIGS. 3a, 3b, 3c, and 3d respectively), material selection, and retrofit strategy. The Electrodynamic Retrofit Film (ERF) 301a, 301b, 301c, 301d is configured to generate an electrodynamic field for the removal of particulate matter from the photovoltaic module with retrofittable electrodynamic cleaning film while maintaining optical transmission and mechanical durability.

In one embodiment, the Electrodynamic Retrofit Film (ERF) 301a, 301b, 301c, 301d disclosed in FIGS. 3a, 3b, 3c, and 3d respectively, includes the one or more nanomaterial electrodes (NMEs) formed in either a one-layer or a two-layer configuration. A one-layer electrode configuration, as illustrated in FIG. 3c and FIG. 3d, is sufficient for two-phase electrode operation, wherein the nanomaterial electrodes (NMEs) are arranged in a single plane relative to the photovoltaic module 302a, 302b, 302c and 302d. In the said configurations, the one or more nanomaterial electrodes (NMEs) (303a, 303b, 303c and 303d disclosed in FIGS. 3a, 3b, 3c, and 3d) may be directly printed onto the surface of the photovoltaic module 302a, 302b, 302c and 302d, as shown in FIG. 3a, FIG. 3b, FIG. 3c and FIG. 3d, or formed on a separate substrate and subsequently coupled to the photovoltaic module by an adhesive layer 306a, 306b, 306c and 306d, as shown in FIG. 3a, FIG. 3b, FIG. 3c and FIG. 3d respectively.

In another example embodiment, the Electrodynamic Retrofit Film (ERF) 301a, 301b includes a two-layer electrode configuration, as illustrated in FIG. 3a and FIG. 3b. The two-layer configuration is used for three-phase electrode layouts. In one implementation, two electrode phases are formed on a first side of a substrate, and a third electrode phase is formed on an opposite side of the substrate. In another implementation, all electrode phases are formed on one side of the substrate while corresponding bus bars are formed on the opposite side. In such implementations, one or more inter-layer connection openings are provided to electrically couple the electrodes and bus bars across the substrate.

In one example embodiment, adhesion of the electrodynamic retrofit film (ERF) 301a to the photovoltaic module follows a sandwiched electrode configuration illustrated in FIGS. 3a-3d. In the said configuration, the nanomaterial electrodes (NMEs) are encapsulated between at least one dielectric layer and at least one adhesion layer, forming a self-contained film structure. The sandwiched ERF 301a is laminated or retrofitted onto the photovoltaic module surface, as illustrated in FIG. 3a and FIG. 3b.

In another example embodiment, adhesion of the electrodynamic retrofit film (ERF) 301a follows a direct adhesion configuration. In this configuration, the nanomaterial electrodes (NMEs) are applied directly onto the glass surface of the photovoltaic module, thereby eliminating a lower substrate layer, as illustrated in FIG. 3c. Direct adhesion reduces the overall thickness of the electrodynamic retrofit film (ERF) but provides reduced flexibility for post-installation retrofit as compared to sandwiched configurations.

In one example embodiment, the electrodynamic retrofit film (ERF) 301a includes a coating layer 304a disposed over the nanomaterial electrodes (NMEs). The coating layer 304a may be formed as a liquid coating or a solid coating. The liquid coatings are configured to self-bond to the underlying electrode or substrate layers during curing. The solid coatings require an additional adhesion layer to ensure mechanical bonding and long-term durability. The coating layer 304a provides environmental protection while maintaining optical transparency and electrical isolation.

In certain embodiments, the described layered configurations enable the electrodynamic retrofit film (ERF) 301a to be selectively adapted for different photovoltaic module types, electrical phase arrangements, and installation requirements while preserving electrodynamic cleaning functionality. In one embodiment, the Electrodynamic Retrofit Film (ERF) 301a includes the nanomaterial electrode (NME) layer 303a-303d configured to control electrodynamic field shape, amplitude, and traveling-wave behavior while maintaining optical transmission. In one embodiment, the nanomaterial electrode (NME) layers 303a-303d includes nanomaterial electrodes arranged in a predefined geometry selected from parallel stripe patterns, spiral patterns, or Hilbert-type patterns.

In one example embodiment, the nanomaterial electrode (NME) layer 303a-303d is configured as a two-phase or a three-phase layout, with bus bars arranged in a central, edge, or distributed topology. In one embodiment, the nanomaterial electrode (NME) layer comprises a single-layer configuration in which all electrode phases are formed on one side of the electrodynamic retrofit film (ERF). In another embodiment, the nanomaterial electrode (NME) layer comprises a two-layer configuration in which electrode phases are distributed across opposing sides of a substrate, or electrode phases are formed on one side and bus bars are formed on the opposite side, with electrical interconnection provided by vias or through-holes. In one embodiment, the spacing between adjacent electrode phases is selected to balance field uniformity and optical loss. In one embodiment, electrode trace width and thickness are selected to balance electric field strength, electrical resistance, and optical transparency. In one embodiment, the nanomaterial electrode (NME) layer is configured to exhibit low electrical resistance along electrode traces and bus bars to reduce voltage drop.

In one example embodiment, electrical interfaces include stable contact resistance at terminations and inter-layer connections. In one embodiment, dielectric spacing between electrode phases is sufficient to withstand operating voltages in a kilovolt range without partial discharge. In one embodiment, the nanomaterial electrode (NME) layer is configured to maintain high optical transmission with minimal haze. In one embodiment, the nanomaterial electrode (NME) layer includes transparent conductive materials such that the electrodes introduce minimal shading. In one embodiment, the nanomaterial electrode (NME) layer includes fine opaque conductive traces aligned with existing photovoltaic bus bars or fingers to minimize additional shading.

In one example embodiment, overall optical transmission loss attributable to the nanomaterial electrodes (NMEs) layer is less than approximately one to two percent at the module level. In one embodiment, the nanomaterial electrodes (NMEs) layer includes conductive materials selected from silver-based, copper-based, transparent oxide-based, carbon-based, or hybrid conductive compositions. In one embodiment, the nanomaterial electrodes (NMEs) layer is formed using a printing or deposition process selected from, but are not restricted to, screen printing, inkjet printing, gravure printing, flexographic printing, sputtering, evaporation, or combinations thereof. In one embodiment, post-deposition processing includes photonic curing, laser sintering, or low-temperature thermal curing compatible with substrate limits.

In one example embodiment, the nanomaterial electrodes (NMEs) layer is configured to resist ultraviolet exposure, humidity, and abrasion through the selection of coating and encapsulation materials. In some embodiments, the nanomaterial electrodes (NMEs) layer is mechanically flexible to accommodate retrofit installation on curved or textured photovoltaic glass. In some embodiments, conductive materials are selected to maintain electrical continuity under bending and thermal cycling. In some embodiments, the nanomaterial electrode (NME) layer is configured for electrical isolation between adjacent phases in accordance with high-voltage clearance requirements. In some embodiments, routing of electrode phases and bus bars is configured to interface with external terminals while maintaining insulation and adhesion compatibility. In some embodiments, electrode geometry and duty cycle are selected to balance cleaning force and optical transmission. In some embodiments, the nanomaterial electrode (NME) layer is configured for scalable manufacturing using roll-to-roll or large-area printing processes.

In one example embodiment, the electrode geometry of the electrodynamic retrofit film (ERF) is selected based on the conductive material used. In some embodiments, the electrodynamic retrofit film (ERF) includes transparent conductive nanomaterial electrodes (NMEs). In an example embodiment, the transparent conductive material includes, but not limited to indium tin oxide, silver nanowires, graphene, or combinations thereof. In an example embodiment, the nanomaterial electrodes (NMEs) are arranged in patterns selected from stripes, meshes, spirals, or fractal layouts. In one embodiment, the transparent electrode patterns maintain high optical transmission.

In one embodiment, the electrodynamic retrofit film (ERF) includes non-transparent conductive nanomaterial electrodes (NMEs). In an example embodiment, the non-transparent conductive material includes, but are not restricted to, silver-based or copper-based inks. In one embodiment, the non-transparent electrodes are arranged as parallel lines. In some embodiments, the parallel electrodes are aligned with photovoltaic bus bars or fingers. In some embodiments, electrode geometry is selected to balance electric field strength, electrical resistance, and optical loss.

In one embodiment, the electrodynamic retrofit film (ERF) includes a transparent and electrically insulating substrate. In an example embodiment, the substrate includes a polymer film. In another example embodiment, the substrate includes glass. In a preferred embodiment, the substrate is selected based on flexibility, durability, and optical transmission.

In one embodiment, the electrodynamic retrofit film (ERF) includes a coating layer disposed over the nanomaterial electrodes (NMEs). In some embodiments, the coating layer provides environmental protection and dielectric isolation. In an example embodiment, the coating layer is ultraviolet stable and optically transparent. In a preferred embodiment, the coating layer includes at least one functional property selected from anti-reflective, anti-soiling, or thermal-management characteristics.

In an example embodiment, the Electrodynamic Retrofit Film (ERF) includes a protective coating layer disposed over the nanomaterial electrodes (NMEs), the coating layer being non-conductive, optically transparent, and environmentally durable, and having a thickness sufficient to provide mechanical protection and dielectric enhancement. The coating layer is selected to increase electric field strength generated by the nanomaterial electrodes (NMEs) while protecting the nanomaterial electrodes (NMEs) from moisture, dust, abrasion, and environmental exposure. In one embodiment, the coating layer comprises a polymer-based dielectric material having a thickness of at least approximately 30 micrometers but is not limited to. In one embodiment, the coating layer is formed as a full-surface coating covering the electrodynamic retrofit film (ERF) to provide uniform protection. In another embodiment, the coating layer is selectively applied over electrode regions to minimize optical loss. Nano-scale surface treatments may be applied as optional surface modifiers but are not relied upon as the primary protective layer. The coating layer is selected to balance dielectric performance, optical transmission, environmental durability, and long-term reliability of the electrodynamic retrofit film (ERF).

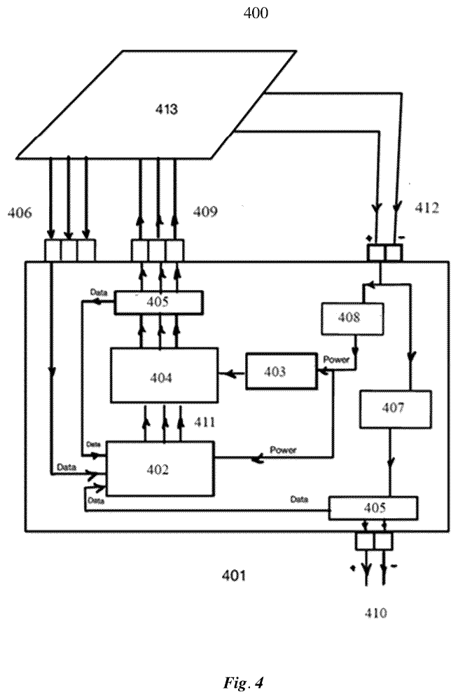

FIG. 4 is a schematic representation of the Power and Control Unit (PCU) configuration that is self-powered from the solar panel, in accordance with embodiments of the present disclosure. FIG. 4 illustrates the Power and Control Unit (PCU) 401 integration of high-voltage generation, control, sensing, and communication circuits and modules on the printed circuit board (PCB) 401 for operation of an electrodynamic retrofit film coupled to a photovoltaic module 413 of the Retrofittable Electrodynamic Cleaning System. The Power and Control Unit (PCU) 401 is configured to generate high-voltage electrical signals, execute control logic, interface with a plurality of sensors, provide communication capabilities, and implement closed-loop feedback control, and optimize an electrical output of the photovoltaic module to operate at or near a maximum power point (MPP) (e.g., via maximum power point tracking (MPPT))

As illustrated in FIG. 4, the PCU 401 is implemented on a printed circuit board (PCB) 401 (PCU 401) and comprises a microprocessor 402, shown as an electrostatic precipitator (ESP) controller configured to control electrodynamic cleaning of the photovoltaic module. The PCB includes only components of the power and control unit (PCU) 401. Accordingly, the PCB and PCU refer to the same assembly for purposes of this disclosure.

In the illustrated embodiment, input power from the photovoltaic module 413 is provided to the PCU 401. A portion of the photovoltaic output is used to supply operating power to electrical components on the PCU 401, including (without limitation) a microprocessor, sensor interface circuitry, and high-voltage supply circuitry. A DC/DC converter 408 is electrically coupled to the photovoltaic input 412 and is configured to convert and regulate the input voltage to one or more stable supply rails required by the PCU 401 (e.g., a first rail such as 12 V for high-voltage boost circuitry and a second rail such as 3.3 V for the microprocessor and low-power electronics, among others). A high-voltage DC booster 403 is electrically coupled to an output of the DC/DC converter 408 and is configured to boost a regulated voltage to a high-voltage level (e.g., on the order of ~1 kV) for generation of high-voltage AC drive signals used by the system.

The output of the high-voltage (HV) DC-DC power booster 403 is provided to an HV switching circuit 404, which selectively routes and modulates the boosted voltage in accordance with control signals 411 from the microprocessor 402 to generate a high-voltage output 409 for driving the electrodynamic retrofit film 413. A plurality of sensors 405 are electrically coupled to the microprocessor 402 and configured to provide sensor data, including, but not limited to, environmental measurements. In addition, the PCU 401 includes at least one power sensors 405 electrically coupled to the microprocessor 402 and configured to measure voltage and current. As illustrated in FIG. 4, one power sensor 405 is electrically coupled to the output of the switching circuit 404 to measure a high-voltage (HV) output power delivered to the electrodynamic retrofit film 413, and a second power sensor 405 is electrically coupled to the DC optimizer 407 to measure an optimized photovoltaic (PV) output power 410 delivered to one or more loads and/or an electrical grid.

The microprocessor 402 receives one or more data such as photovoltaic module data 405 and sensors data 406, processes the received data, and generates control signals 411 to regulate the operation of the DC-DC power booster 403 and switching circuit 404. The one or more communication, power and data lines illustrated in FIG. 4 provide bidirectional data exchange between the PCU 401, the photovoltaic module 413, and external systems for closed-loop control of high-voltage generation and electrodynamic cleaning of the electrodynamic retrofit film 413.

In one example embodiment, and with reference to FIG. 4, the Power and Control Unit (PCU) 401 includes a DC-DC power booster 403 configured to convert a low-voltage input into a high-voltage DC output. The DC-DC power booster 403 is configured to generate an adjustable output voltage in a range of approximately 1,000 volts to 5,000 volts at an output power level of approximately 0.5 watts to 5 watts, with output current in a microampere to milliampere range suitable for driving an electrodynamic retrofit film 413. The DC-DC power booster 403 supplies high-voltage power to a switching circuit 404 for the generation of multi-phase high-voltage signals.

In one embodiment, the DC-DC power booster 403 is implemented as a custom high-voltage converter rather than an off-the-shelf module, for improved stability, reduced ripple, tighter integration, and reduced cost. In one embodiment, the DC-DC power booster 403 comprises a flyback converter topology providing galvanic isolation and a high step-up voltage ratio. The flyback converter includes a primary-side switching device controlled by pulse-width-modulated (PWM) signals and a transformer configured to store energy during an on-time interval and transfer the stored energy to a secondary-side high-voltage rectifier network during an off-time interval.

In one embodiment, the secondary-side circuitry of the DC-DC power booster 403 includes a high-voltage rectifier stage and an output capacitor network configured to store and filter the generated high-voltage DC. In one embodiment, the secondary-side circuitry further includes a voltage multiplier stage to achieve output voltages above approximately 2 kilovolts. Output filtering and discharge components are provided to limit ripple, control electromagnetic interference, and enable safe discharge during shutdown.

In one embodiment, regulation and control of the DC-DC power booster 403 are provided by the microprocessor 402. The microprocessor 402 generates control signals to regulate switching frequency and duty cycle and receives high-voltage feedback through a resistive divider network coupled to the high-voltage output. In one embodiment, the DC-DC power booster 403 includes protection features comprising primary-side current limiting, over-voltage protection, under-voltage lockout, and thermal protection. The DC-DC power booster 403 is mounted on the printed circuit board 401.

In one embodiment, and with reference to FIG. 4, the Power and Control Unit (PCU) 401 includes a three-phase high-voltage (HV) power output 409 configured to energize the electrodynamic retrofit film 413 coupled to a photovoltaic module. The HV power output 409 is the high-voltage output voltage 409, implemented on a printed circuit board 401 and includes the DC-DC power booster 403 and the switching circuit 404. The DC-DC power booster 403 is configured to receive a low-voltage input from a primary power source 405, such as a 12-volt supply, and to generate an elevated voltage. The switching circuit 404 receives the boosted voltage and generates three phase-shifted high-voltage output voltage 409, which are provided at an HV output terminal for connection to the electrodynamic retrofit film (ERF) nanomaterial electrodes (NMEs) of the photovoltaic module.

In one embodiment, the switching circuit 404 includes one or more high-voltage gate driver circuits. The high-voltage gate driver circuits are configured to reliably switch the high-voltage signals under the control of a microprocessor 402. The microprocessor 402 controls switching timing, duty cycle, and phase separation of the output signals of the switching circuit 404. The three high-voltage output phases are pulse-width modulated (PWM) and phase-shifted by approximately 120 degrees relative to one another to generate a traveling electrodynamic wave across the electrodynamic retrofit film (ERF). The switching circuit 404 generates three phase-shifted high-voltage output voltage 409 in a range of approximately 1.2 kilovolts to 5 kilovolts, depending on the nanomaterial electrode (NME) geometry and RECS system configuration. The operating current of the switching circuit 404 can be low due to the open-ended nature of the nanomaterial electrode (NME) of the electrodynamic retrofit film (ERF), such that the HV power supply operates as a high-voltage, low-power subsystem.

The microprocessor 402 processes sensor data received from sensors 405 and generates control signals to regulate the operation of the DC-DC power booster 403 and the switching circuit 404. During operation, the sequential charging of the nanomaterial electrode (NME) of the electrodynamic retrofit film (ERF) by the three-phase high-voltage signals produces electrostatic forces that repel and displace dust particles from the surface of the photovoltaic module.

In one embodiment, and with reference to FIG. 4, the Power and Control Unit (PCU) 400 includes the high-voltage gate driver circuits implemented within the switching circuit 404. The high-voltage gate driver circuits are configured to selectively couple each phase output of the HV power supply to a high-voltage rail generated by a DC-DC power booster 403 or to a reference potential, such as ground, under control of the microprocessor 402. In one embodiment, each phase of the high-voltage gate driver circuits is implemented using a single-pole double-throw (SPDT) switching configuration, wherein an associated nanomaterial electrode (NME) of the electrodynamic retrofit film (ERF) is alternately connected to the high-voltage rail or to ground. In one embodiment, the SPDT configuration is realized using two single-pole single-throw (SPST) switches controlled by pulse-width-modulated control signals generated by the microprocessor 402.

In another embodiment, each phase of the high-voltage gate driver circuits is implemented using a single SPST switch coupled to the high-voltage rail and a resistive discharge path to ground. The resistive discharge path simplifies control by eliminating dead-time requirements, while dissipating charge through a high-value resistor. In one embodiment, the switching circuit 404 includes electromechanical switching devices configured to implement SPDT or SPST switching for prototype or low-frequency operation. The said switching devices in the switching circuit 404 provide direct switching between the high-voltage rail and ground but are limited in switching speed, voltage capability, and operational lifetime.

In an example embodiment, the switching circuit 404 includes solid-state relay devices electrically isolated from the microprocessor 402 and controlled by logic-level signals. The solid-state relay devices provide non-mechanical switching of high-voltage signals and are configured for operation at voltages up to approximately 1.5 kilovolts.

In an example embodiment, the switching circuit 404 includes discrete high-voltage MOSFET devices arranged in a high-side and low-side configuration. The MOSFET devices are controlled by a dedicated gate driver circuit, electrically isolated from the microprocessor 402. In one embodiment, the high-voltage gate driver circuit is configured as a bootstrap driver to provide gate drive voltage for the high-side MOSFET.

In one example embodiment, the high-voltage gate driver circuit includes an isolated dual-channel gate driver configured to control both high-side and low-side MOSFETs while providing galvanic isolation between logic-level control signals and the high-voltage switching stage. The MOSFET devices are selected to withstand operating voltages of at least approximately 1.7 kilovolts and to support high-frequency pulse-width-modulated operation.

In one embodiment, the microprocessor 402 controls switching timing, duty cycle, and phase offset of the switching circuit 404 to generate three phase-shifted high-voltage output signals 409 supplied to the electrodynamic retrofit film (ERF). The high-voltage gate driver circuit thereby enables efficient, low-current, high-voltage operation suitable for long-term electrodynamic cleaning of a photovoltaic module.

In one embodiment, and with reference to FIG. 4, the Power and Control Unit (PCU) 401 further includes the plurality of sensor circuits 406 configured to support monitoring, logging, and control of an electrodynamic retrofit film coupled to a photovoltaic module. The plurality of sensor circuits 405 is electrically coupled to a microprocessor 402 and is configured to generate sensor data signals representative of environmental operating conditions but is not restricted to.

In one example embodiment, the sensor circuit 406 includes a temperature sensor configured to monitor ambient and internal temperatures of the PCU 401, providing overheating protection. In one embodiment, the temperature sensor generates an analog signal conditioned for input to an analog-to-digital converter of the microprocessor 402. In an example embodiment, the PCU 401 includes a temperature sensor, such as, but not limited to, a Vishay NTCLE100-series NTC thermistor conditioned by an MCP6006 operational amplifier, for monitoring ambient and internal temperatures.

In another embodiment, the plurality of sensor circuits 406 includes an irradiance sensor configured to measure incident solar radiation on the photovoltaic module but not limited to PDB-C139 photodiode with transimpedance amplification, for measuring incident solar radiation. The irradiance sensor 406b generates an electrical signal proportional to solar input, enabling estimation of expected photovoltaic output. In an example embodiment, the plurality of sensor circuits 406 may also comprises one or more electrical power sensing circuits configured for operation in proximity to high-voltage switching circuit 404, and the plurality of sensor circuits 406 includes analog signal-conditioning features comprising, but not restricted to, pseudo-ground biasing, low-pass RC filtering, instrumentation-grade analog-to-digital conversion conditioning, and isolation-aware routing to reduce noise and interference from the high-voltage generator.

In one embodiment, the plurality of sensor circuits 405 includes one or more power sensor configured to measure electrical parameters including voltage, current, or power associated with the photovoltaic module or the PCU 400. The power sensors 405 are configured to provide feedback data used to evaluate system efficiency and infer soiling-related performance losses. In one embodiment, the microprocessor 402 processes sensor signals received from the plurality of sensor circuits 405 to estimate photovoltaic module performance, soiling levels, operating efficiency and determine control actions for electrodynamic cleaning.

In one embodiment, a DC optimizer 407 is configured to optimize a remaining portion of power generated by the photovoltaic module that is not consumed by the PCU, by operating the photovoltaic module at or near a maximum power point (MPP) and delivering the optimized power to an electrical grid and/or one or more external loads.

In this example embodiment, the PCU 401 further includes one or more communication interfaces, such as an SD card module, an Ethernet interface, or a Wi-Fi module, enabling local data logging and remote monitoring and control of RECS operation. In one embodiment, the sensor data and operational data from the sensor circuits 405 are logged locally or transmitted to an external platform via the PCU 400, for manual or automated control of dust-removal operations performed by the electrodynamic retrofit film 413.

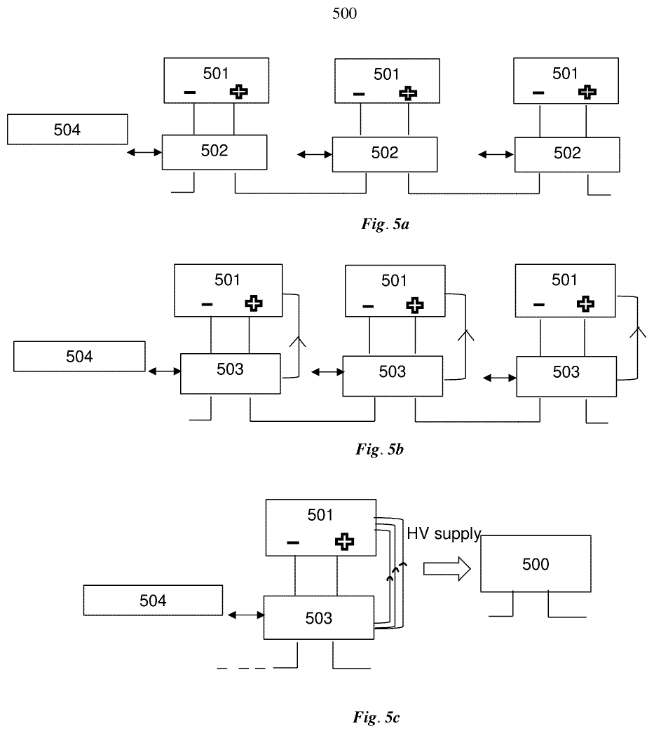

FIG. 5a illustrates a schematic representation of one or more power extraction circuits in a Retrofittable electrodynamic Cleaning System (RECS) 500 in accordance with the embodiments of the invention. The Retrofittable electrodynamic Cleaning System (RECS) 500 is deployed across a plurality of photovoltaic modules 501 with integration of one or more maximum power point tracking (MPPT) unit 502 at different system levels. As shown in FIG. 5a, the plurality of photovoltaic modules 501 are electrically coupled in strings to deliver generated power to one or more downstream power conversion equipment. In an alternative configuration illustrated in FIG. 5a, each photovoltaic module 501 is coupled to a module-level MPPT unit 502. Each MPPT unit 502 is configured to locally track a maximum power point of the associated photovoltaic module 501 and deliver optimized power to a common string output, thereby reducing mismatch losses. The MPPT units 502 may further include wireless communication modules 504 to transmit one or more operating data of the Retrofittable electrodynamic Cleaning System (RECS) 500.

FIG. 5b illustrates one or more power extraction circuits comprises one or more maximum power point tracking (MPPT) units 502 coupled to the power and control unit (PCU) 503 in the Retrofittable electrodynamic Cleaning System (RECS) 500. In a further embodiment shown in FIG. 5b, each photovoltaic module 501 is coupled to a Power and Control Unit (PCU) 503. The PCU 503 includes an integrated low-power DC extraction stage configured to draw operating power directly from the photovoltaic panel 501, thereby eliminating the need for an external low-voltage power supply. The PCU 503 further includes MPPT unit 502 configured to optimize power extraction from the photovoltaic module 501 while supplying a portion of the extracted power to internal control electronics of the RECS system 500. In one embodiment, the PCU 503 draws approximately two watts to power electrodynamic cleaning and control functions while allowing remaining power to be delivered to an inverter or string connection.

The PCU 503 further includes a wireless communication 504 operatively coupled to the microprocessor of the RECS system 500 and configured to connect the RECS 500 to a software module 105 (As illustrated in FIG. 1) for data monitoring and remote control. The wireless communication 504 provides network connectivity and enables remote control of dust removal operations as well as automated control based on sensor data and instructions received to and from the software module 105.

In one embodiment, and with reference to FIG. 5b, the Power and Control Unit (PCU) 503 includes an integrated maximum power point tracking (MPPT) unit 502 such that the PCU 503 is configured with a mechanical form factor and mounting interface substantially similar to commercially available microinverters and DC optimizers. The PCU 503 is configured for attachment to the rear surface of a photovoltaic module 501 using standard panel-level power electronics mounting hardware.

In one embodiment, the PCU 503 is electrically coupled to the photovoltaic module 501 at the same electrical insertion point used by conventional microinverters or DC optimizers, thereby providing series-string compatibility and simplifying array-level wiring. The PCU 503 is configured to deliver optimized power from the photovoltaic panel 501 to a string or inverter connection while drawing operating power for internal control and electrodynamic cleaning functions.

In one embodiment, the PCU 503 provides a uniform hardware footprint consistent with existing panel-level power electronics, thereby enabling installers to mount, wire, and service the PCU 503 using established installation practices. In this configuration, the PCU 503, together with the integrated MPPT unit 502, provides dual functionality comprising panel-level power optimization and electrodynamic dust removal while occupying a same installation location as a conventional microinverter or DC optimizer.

FIG. 5c illustrates the self-contained RECS 500 integrating the photovoltaic module 501, the PCU 503 with MPPT unit 501, in accordance with the embodiments of the disclosure. The RECS 500 further comprises electrodynamic cleaning components forming the self-contained RECS 500. The RECS 500 is the smart photovoltaic module 505 configured to autonomously power itself, optimize the electrical output, perform dust removal, communicate wirelessly without requiring additional low-voltage wiring infrastructure and monitoring solar yield data.

In another embodiment, the RECS system 500 incorporates a high-voltage safety architecture with integrated electromagnetic interference (EMI) mitigation. The high-voltage safety architecture includes suppression networks coupled to high-voltage switching nodes, defined creepage and clearance spacing between conductive elements, electrical interlocks that inhibit switching during fault or access conditions, and arc-over suppression features integrated into the enclosure and circuit layout. The printed circuit board and mechanical design of the system 500 are arranged to satisfy high-voltage and electrostatic discharge (ESD) pre-certification requirements, enabling compliance with applicable safety and electromagnetic compatibility standards.

In a further embodiment, the Power and Control Unit (PCU) 503 of the RECS 500 is configured as a scalable, panel-level device suitable for large-scale deployment. The PCU 503 form factor, mounting interfaces, and wiring conventions are dimensioned to match those of existing microinverters and DC optimizers, including compatibility with standard mounting rails and junction box practices. Electrically, the PCU 503 presents string-compatible behavior, allowing multiple units to be deployed across an array without modifying established installation workflows. The architecture of the RECS 500 enables utility-scale integration of the RECS system 500 while preserving conventional solar installation procedures.

In one or more embodiments, the autonomous removal of debris from a photovoltaic module is performed by a retrofittable electrodynamic cleaning system (RECS) 500, as described with reference to FIG. 1 through FIG. 5, wherein the disclosed method steps are executed through coordinated operation of components of the RECS 500. The RECS 500 enables implementation of the method as an integrated, self-powered, and autonomous cleaning solution for photovoltaic modules.

According to one embodiment, the RECS 500 includes an electrodynamic retrofit film (ERF) disposed on a light-receiving surface of the photovoltaic module. The electrodynamic retrofit film (ERF) comprises a plurality of nanomaterial electrodes (NMEs) arranged in one or more layers, as illustrated in FIG. 3. The nanomaterial electrodes (NMEs) are formed from optically transparent, electrically conductive nanomaterials and are configured to maintain high optical transmittance while enabling the generation of electrodynamic forces. The electrodynamic retrofit film (ERF) functions as a surface-level cleaning actuator of the RECS.

In one embodiment, the RECS 500 further includes a power and control unit (PCU) mounted on the photovoltaic module, as shown in FIG. 1 through FIG. 5. The PCU is electrically coupled to the electrodynamic retrofit film (ERF) and to electrical output terminals of the photovoltaic module. The PCU 503 is implemented on a single printed circuit board and includes a high-voltage generator, a power extraction circuit, a microprocessor, a plurality of sensor circuits, and a wireless communication module. The PCU cooperates with the electrodynamic retrofit film (ERF) to execute autonomous electrodynamic cleaning operations.

In operation, the power extraction circuit of the PCU illustrated in FIG. 5a, FIG. 5b and FIG. 5c draws operating power directly from the photovoltaic module. The microprocessor executes a maximum power point tracking (MPPT) algorithm to regulate the extracted power such that the PCU 503 operates in a self-powered manner without substantially degrading energy delivery from the photovoltaic module. As depicted in FIG. 5a, FIG. 5b and FIG. 5c. this configuration enables the RECS 500 to remain energetically autonomous while preserving normal photovoltaic power generation. In one embodiment, the plurality of sensor circuits integrated within the PCU monitor one or more environmental parameters and electrical performance parameters of the photovoltaic module. The sensor circuits provide real-time or periodic data to the microprocessor, thereby forming a sensing and diagnostics subsystem of the RECS 500.

The microprocessor, in response to sensor data, processes the data to estimate the soiling condition of the photovoltaic module. The soiling condition corresponds to an operational state of the RECS 500 and is used to determine when cleaning is required. This processing enables the RECS 500 to autonomously transition between monitoring and cleaning modes without external intervention.

When the estimated soiling condition satisfies a predetermined criterion, the microprocessor autonomously commands the high-voltage generator within the PCU to initiate a cleaning cycle. The high-voltage generator produces a multi-phase, high-voltage alternating-current (AC) waveform, which is supplied to the plurality of nanomaterial electrodes (NMEs) of the electrodynamic retrofit film (ERF). The application of the multi-phase high-voltage AC waveform to the nanomaterial electrodes (NME) generates an electrodynamic travelling wave across the light-receiving surface of the photovoltaic module, as schematically illustrated in FIG. 3a, FIG. 3b, FIG. 3c and FIG. 3d. The travelling wave induces electrodynamic forces that dislodge and transport debris away from the surface, thereby restoring optical transmission and electrical performance of the photovoltaic module.

During or after the cleaning cycle, the sensor circuits provide sensor feedback to the microprocessor. The microprocessor evaluates the sensor feedback to verify cleaning effectiveness, including detection of improvements in electrical output or changes in environmental indicators, as represented in FIG. 5. In one embodiment, based on the sensor feedback, the microprocessor adjusts subsequent cleaning operation parameters of the RECS, including, but not limited to, waveform amplitude, frequency, phase relationships, cleaning duration, and cleaning intervals. The closed-loop feedback control enables adaptive and autonomous optimization of electrodynamic cleaning performance of the RECS over time.

Accordingly, the disclosed method is inherently integrated with the RECS described in FIG. 1-FIG. 5, wherein the electrodynamic retrofit film (ERF) with nanomaterial electrodes (NMEs), the PCU with the microprocessor, the power extraction circuit, the sensor circuits, and the high-voltage generator collectively function as an integrated RECS to autonomously remove debris from the photovoltaic module.

In an example embodiment, the present disclosure includes providing a compact, integrated hardware apparatus configured to generate controlled three-phase high-voltage electrical signals suitable for electrodynamic dust removal on photovoltaic (PV) modules. The disclosure further seeks to enable fully autonomous, closed-loop cleaning operation through the use of embedded sensing circuits and onboard control logic. Another objective is to eliminate reliance on external power sources by extracting operating power directly from the associated PV module and incorporating an integrated, high-efficiency maximum power point tracking (MPPT) stage.

The disclosure also aims to consolidate power conversion, sensing, communication, and control circuitry onto a single printed circuit board, thereby improving manufacturability, operational reliability, and scalability for large-scale deployment. Additional objectives include providing robust high-voltage safety features, electromagnetic interference mitigation, and environmental durability suitable for long-term outdoor operation in solar farm environments, enabling a retrofit-ready device attachable to existing PV panels with minimal installation effort, and supporting remote monitoring and wireless control in conjunction with cloud-based performance analytics systems.

In one embodiment, the disclosed RECS system is implemented as a completely water-free and maintenance-free cleaning module, wherein dust removal is performed using electrodynamic forces without the use of brushes, fluids, or moving mechanical components, thereby reducing wear and prolonging the operational lifetime of a photovoltaic panel. In this embodiment, a fully integrated high-voltage and control architecture is provided, wherein a high-voltage power booster, gate driver circuitry, embedded sensors, and a maximum power point tracking (MPPT) stage are integrated onto a single printed circuit board.

In this embodiment, the system operates autonomously using onboard logic that continuously or periodically evaluates measured irradiance, temperature, and electrical power parameters to estimate soiling conditions of the photovoltaic panel. Based on this evaluation, the system selectively initiates an electrodynamic dust-removal cycle only when cleaning is determined to be beneficial, thereby minimizing energy consumption. The system is self-powered through an embedded MPPT architecture that extracts a limited amount of operating power directly from the photovoltaic panel, eliminating the need for external power wiring or distributed auxiliary power infrastructure.

In an embodiment, the retrofittable electrodynamic cleaning system (RECS) is configured as a modular retrofit assembly. The retrofittable electrodynamic cleaning system (RECS) is dimensioned and mechanically configured for on-panel mounting and utilizes standard photovoltaic connector interfaces to enable simplified electrical integration. The form factor and mounting approach are preferably analogous to those of commercially deployed microinverters or DC power optimizers, such that the RECS can be attached to a photovoltaic module frame or associated mounting rails while interfacing with existing panel wiring with minimal modification.

In an aspect, the modular configuration enables the RECS to function as a plug-and-play retrofit for existing photovoltaic installations. Installation may be performed by affixing the electrodynamic retrofit film to the light-receiving surface of the photovoltaic module, electrically coupling leads of the electrodynamic retrofit film to the power and control unit (PCU), and electrically connecting an input of the PCU to a junction box or output cables of the photovoltaic module.

In yet another aspect, the RECS is configured to operate without external power supplies or additional field wiring, wherein operating power is drawn directly from the photovoltaic module via the integrated power extraction circuit. This self-contained, modular architecture enables rapid deployment, reduced installation complexity, and compatibility with a wide range of existing photovoltaic module installations.

In an embodiment, the high-voltage circuitry of the RCES system is designed with integrated electromagnetic interference mitigation, electrical isolation, and safety spacing to support reliable long-term outdoor operation. The printed circuit board and enclosure are configured for low-cost manufacturing and large-scale deployment, providing a unified and industrially scalable solution for electrodynamic dust removal on photovoltaic installations.

In a preferred embodiment of the invention, a method for autonomously removing debris from a photovoltaic module using a retrofittable electrodynamic cleaning system is disclosed. The method comprises providing an electrodynamic retrofit film (ERF) on a light-receiving surface of the photovoltaic module, the electrodynamic retrofit film (ERF) comprises a plurality of nanomaterial electrodes (NMEs) arranged in one or more layers. The method further comprises mounting a power and control unit (PCU) on the photovoltaic module, the PCU is electrically connected to the electrodynamic retrofit film (ERF) and to electrical output terminals of the photovoltaic module. The PCU is integrated on a single printed circuit board and includes a high-voltage generator, at least one power extraction circuit, a microprocessor, a plurality of sensor circuits, and a wireless communication module. The method further comprises drawing operating power for the PCU directly from the photovoltaic module using the at least one power extraction circuit and regulating the drawn power using a maximum power point tracking (MPPT) algorithm such that the PCU operates in a self-powered manner without substantially degrading energy delivery from the photovoltaic module.

The method further comprises monitoring, using the plurality of sensor circuits, one or more environmental parameters and operating parameters of the photovoltaic module and the electrodynamic retrofit film (ERF). The method further comprises processing sensor data from the plurality of sensor circuits using the microprocessor to estimate the soiling condition of the photovoltaic module. The method further comprises autonomously initiating a cleaning cycle by activating the high-voltage generator to generate a multi-phase, high-voltage alternating-current (AC) waveform based on the estimated soiling condition. The method further comprises applying the multi-phase high-voltage AC waveform to the plurality of nanomaterial electrodes (NMEs) to generate an electrodynamic travelling wave across the light-receiving surface of the photovoltaic module for dislodging and transporting debris from the surface. The method further comprises monitoring sensor feedback during or after the cleaning cycle to verify cleaning effectiveness. The method further comprises adjusting subsequent cleaning operation parameters based on the sensor data as closed-loop feedback for autonomous electrodynamic cleaning of the photovoltaic module.

Further, high-voltage alternating-current waveform is a three-phase AC waveform sequentially energizing different sets of the plurality of electrodes to propagate the traveling electrostatic field. The method of extracting electrical power from the photovoltaic module comprises operating the maximum power point tracking module to draw power at an optimal power point with minimal impact on energy production. Furthermore, the method allows estimating the soiling condition by detecting a reduction in photovoltaic power output exceeding a predetermined threshold relative to irradiance. The method allows transmitting operational data including sensor measurements and cleaning cycle history to a remote monitoring platform via the wireless communication module. The method also allows receiving a remote command via the wireless communication module to initiate a cleaning cycle independently of the estimated soiling condition.

It is to be understood that the above description is intended to be illustrative, and not restrictive. Many other embodiments will be apparent to those of skill in the art upon reviewing the above description. The scope should, therefore, be determined with reference to the appended claims, along with the full scope of equivalents to which such claims are entitled.

Although numerous characteristics and advantages of the present invention have been set forth in the foregoing description, together with details of the structure and function of the invention, the disclosure is illustrative only, and changes may be made in detail within the principles of the invention to the full extent indicated by the broad general meaning of the terms in which the appended claims are expressed.

It is to be understood that the embodiments described herein are provided for purposes of illustration and are not intended to limit the scope of the present invention. The specific configurations, structural arrangements, dimensions, material selections, and parameter values disclosed are exemplary in nature. Variations, modifications, substitutions, and equivalents that achieve substantially the same function or result may be employed without departing from the spirit and scope of the invention as defined by the appended claims. The disclosed embodiments are therefore not restricted to the numerical ranges, or example values presented herein.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

1. A retrofittable electrodynamic cleaning system for a photovoltaic module, comprising:
an electrodynamic retrofit film (ERF) affixed to a light-receiving surface of the photovoltaic module, the electrodynamic retrofit film (ERF) comprises a plurality of nanomaterial electrodes (NMEs) arranged in one or more layers; and
a power and control unit (PCU) electrically connected to the electrodynamic retrofit film (ERF), wherein the PCU comprises:
at least one high-voltage generator, wherein:
the at least one high-voltage generator receives a low direct-current (DC) voltage and generates a higher-voltage, multi-phase alternating-current (AC) voltage waveform,
the at least one high-voltage generator comprises one or more multi-phase switching circuits electrically coupled to the plurality of nanomaterial electrodes (NMEs), further wherein:
the one or more multi-phase switching circuits applies the multi-phase AC voltage waveform to the plurality of nanomaterial electrodes (NMEs) to generate an electrodynamic travelling wave for repelling and removing debris from the light-receiving surface of the photovoltaic module;
at least one power extraction circuit electrically connectable to one or more output terminals of the photovoltaic module, wherein:
the power extraction circuit comprises one or more maximum power point tracking (MPPT) modules, further wherein:
the one or more MPPT modules execute a maximum power point tracking logic to draw operating power from the photovoltaic module for self-powered operation;
a plurality of sensor circuits, wherein:
the plurality of sensor circuits receive one or more sensor signals indicative of one or more environmental and operating parameters of the photovoltaic module and the electrodynamic retrofit film (ERF);
a microprocessor operatively coupled to the high-voltage generator, the one or more multi-phase switching circuit, the power extraction circuit, and the plurality of sensor circuits, wherein:
the microprocessor processes the sensor signals to determine a soiling condition of the photovoltaic module and to initiate and control cleaning cycles of the electrodynamic retrofit film (ERF) based on the determined soiling condition; and
a wireless communication module operatively coupled to the microprocessor, wherein the wireless communication module communicatively couples the microprocessor to a remote software module network for data monitoring and remote control,
wherein the PCU is integrated on a single printed circuit board and implements closed-loop feedback to dynamically initiate, control, and verify electrodynamic cleaning cycles based on the one or more sensor signals.

2. The system of claim 1, wherein the high-voltage generator is configured to generate a three-phase alternating-current voltage waveform, and wherein the plurality of nanomaterial electrodes (NMEs) is arranged into three interleaved phase groups to produce a laterally propagating electrodynamic travelling wave.

3. The system of claim 1, wherein the high-voltage generator comprises a hybrid switching architecture including at least one of MOSFET-based switches, solid-state relays, or electromechanical relays configured to generate the multi-phase AC voltage waveform.

4. The system of claim 1, wherein the high-voltage generator further comprises a DC-DC booster circuit including a flyback converter coupled to a voltage multiplier network configured to generate an output voltage of more than 2 kilovolts.

5. The system of claim 1, wherein the power extraction circuit is configured to limit power drawn from the photovoltaic module to a level without materially interfering with normal operation of an inverter, optimizer, or string-level power electronics connected to the photovoltaic module.

6. The system of claim 1, wherein the plurality of sensor circuits includes at least one of an irradiance sensor, a humidity sensor, a temperature sensor, a voltage sensor, a current sensor, or a power sensor, and wherein the microprocessor determines the soiling condition by comparing measured electrical output to an expected electrical output normalized to irradiance.

7. The system of claim 1, wherein the plurality of sensor circuits comprises one or more electrical power sensing circuits configured for operation in proximity to high-voltage switching circuit, and the plurality of sensor circuits includes analog signal-conditioning features comprising pseudo-ground biasing, low-pass RC filtering, instrumentation-grade analog-to-digital conversion conditioning, and isolation-aware routing to reduce noise and interference from the high-voltage generator.

8. The system of claim 1, wherein the microprocessor is configured to support multiple operating modes, including a fully autonomous mode, a remote-controlled mode via the wireless communication module, and a manual mode initiated by a local user input.

9. The system of claim 1, wherein the wireless communication module is further configured to enable remote monitoring, configuration, and firmware updates via the remote software module network.

10. The system of claim 1, wherein the PCU further comprises electromagnetic interference suppression circuitry, high-voltage isolation spacing, and arc-over suppression features.

11. The system of claim 1, wherein the PCU is housed within an outdoor-rated, weather-resistant enclosure configured for mounting to a rear frame, junction box region, or racking structure of the photovoltaic module.

12. The system of claim 1, wherein the electrodynamic retrofit film (ERF) comprises nanomaterial electrodes (NMEs) formed from a transparent conductive material selected from the group consisting of indium tin oxide (ITO), aluminum-doped zinc oxide (AZO), silver nanowires, carbon nanotube networks, and transparent conductive oxide composites.

13. The system of claim 1, wherein the PCU is configured for retrofit installation without modification of a glass laminate, junction box, or electrical wiring of the photovoltaic module.

14. The system of claim 1, wherein the microprocessor is further configured to inhibit initiation of a cleaning cycle when the sensor signals indicate at least one of rain, excessive humidity, or unsafe electrical operating conditions.

15. A method for autonomously removing debris from a photovoltaic module using a retrofittable electrodynamic cleaning system, the method comprising:
providing an electrodynamic retrofit film (ERF) on a light-receiving surface of the photovoltaic module, the electrodynamic retrofit film (ERF) comprises a plurality of nanomaterial electrodes (NMEs) arranged in one or more layers;
mounting a power and control unit (PCU) on the photovoltaic module, the PCU is electrically connected to the electrodynamic retrofit film (ERF) and to electrical output terminals of the photovoltaic module,
wherein the PCU is integrated on a single printed circuit board and includes a high-voltage generator, at least one power extraction circuit, a microprocessor, a plurality of sensor circuits, and a wireless communication module;
drawing operating power for the PCU directly from the photovoltaic module using the at least one power extraction circuit, and regulating the drawn power using a maximum power point tracking (MPPT) algorithm such that the PCU operates in a self-powered manner without substantially degrading energy delivery from the photovoltaic module;
monitoring, using the plurality of sensor circuits, one or more environmental parameters and operating parameters of the photovoltaic module and the electrodynamic retrofit film (ERF);
processing sensor data from the plurality of sensor circuits using the microprocessor to estimate the soiling condition of the photovoltaic module;
autonomously initiating a cleaning cycle by activating the high-voltage generator to generate a multi-phase, high-voltage alternating-current (AC) waveform based on the estimated soiling condition;
applying the multi-phase high-voltage AC waveform to the plurality of nanomaterial electrodes (NMEs) to generate an electrodynamic travelling wave across the light-receiving surface of the photovoltaic module for dislodging and transporting debris from the surface;
monitoring sensor feedback during or after the cleaning cycle to verify cleaning effectiveness; and
adjusting subsequent cleaning operation parameters based on the sensor data as closed-loop feedback for autonomous electrodynamic cleaning of the photovoltaic module.

16. The method of claim 15, wherein the high-voltage alternating-current waveform is a three-phase AC waveform, and wherein applying the waveform comprises sequentially energizing different sets of the plurality of electrodes to propagate the travelling electrostatic field.

17. The method of claim 15, wherein extracting electrical power from the photovoltaic module comprises operating the maximum power point tracking module to draw power at an optimal power point with minimal impact on energy production.

18. The method of claim 15, wherein estimating the soiling condition comprises detecting a reduction in photovoltaic power output exceeding a predetermined threshold relative to irradiance.

19. The method of claim 15, further comprising transmitting operational data including sensor measurements and cleaning cycle history to a remote monitoring platform via the wireless communication module.

20. The method of claim 15, further comprising receiving a remote command via the wireless communication module to initiate a cleaning cycle independently of the estimated soiling condition.
